(19) United States
(12) Patent Application Publication
(10) Pub. No.: US 2022/0255081 A1
(43) Pub. Date: Aug. 11, 2022

(54) SECONDARY BATTERY, ELECTRONIC DEVICE, AND POWER TOOL

(71) Applicant: MURATA MANUFACTURING CO., LTD., Kyoto (JP)

(72) Inventor: Koji SHIBUTANI, Kyoto (JP)

(21) Appl. No.: 17/724,777

(22) Filed: Apr. 20, 2022

Related U.S. Application Data
(63) Continuation of application No. PCT/JP2020/044026, filed on Nov. 26, 2020.

(30) Foreign Application Priority Data
Dec. 25, 2019 (JP) 2019-234160

(51) Int. Cl. H01M 4/62; H01M 10/0587

(52) U.S. Cl. CPC H01M 4/62; H01M 2004/028; H01M 2220/30; H01M 10/0587

(57) ABSTRACT

Provided is a secondary battery including an electrode wound body having a structure in which a positive electrode having a belt shape and a negative electrode having a belt shape are stacked and wound with a separator interposed between the positive electrode having a belt shape and the negative electrode having a belt shape and an exterior can housing the electrode wound body, in which the positive electrode includes positive electrode active material layers on both surfaces of a positive electrode foil having a belt shape, the positive electrode has two edges being intersections of an end surface on a winding start side and surfaces of the positive electrode active material layers in sectional view of the positive electrode, and an insulating member having a length of 10 mm or more and 40 mm or less is disposed on a surface of the separator on the winding start side of the electrode wound body at a position facing at least one of the edges of a positive electrode.

### CROSS REFERENCE TO RELATED APPLICATIONS

The present application is a continuation of PCT patent application no. PCT/JP2020/044026, filed on Nov. 26, 2020, which claims priority to Japanese patent application no. JP2019-234160, filed on Dec. 25, 2019, the entire contents of which are being incorporated herein by reference.

### BACKGROUND

The present application relates to a secondary battery, an electronic device, and a power tool.

Lithium ion batteries are becoming widely used in automobiles, machines, and the like, and high-output batteries are required. As one of methods for producing this high output, a battery structure capable of high-rate discharging has been proposed. By disposing a positive electrode lead at the intermediate portion in the length direction of a positive electrode having a belt shape, it is possible to reduce the internal resistance of the battery and to perform discharging (high-rate discharging) in which a relatively large current flows. While high-rate discharging and charging are repeated, the negative electrode is deformed by repeated great expansion and contraction as compared with the case of normal charging and discharging, and there has been a possibility that an end portion of the positive electrode breaks through the separator to cause an internal short circuit (short circuit).

A cylindrical battery is provided and having a wound structure, both end portions of a separator in a winding direction are bent to form a structure in which two layers of the separator are stacked on an end portion of a positive electrode, so that the end portion of the positive electrode is made less likely to break through the separator.

### SUMMARY

The present application relates to to a secondary battery, an electronic device, and a power tool.

It is difficult to produce the separator such that two layers of the separator is stacked on the end portion of the positive electrode by bending both end portions of the separator in the winding direction with a winding device, and there has been a problem that a battery having such a structure is poor in producibility (cannot be mass-produced). Since one end on the winding start side of the positive electrode has a smaller bending radius than the other end on the winding end side, the pressure received by the separator in contact with the edge is higher than the other end. In the case of the structure in which one side or both sides of the positive electrode current collector are exposed at one end on the winding start side of the positive electrode, the step is smaller than that in the case of the structure in which the current collector is not exposed, so that the separator breakage at the end portion of the positive electrode is less likely to occur. However, in the case of a battery having the structure in which the current collector is not exposed at one end on the winding start side of the positive electrode, when charging and discharging are repeated, the separator in contact with the edge of the end surface of the positive electrode is subjected to a large pressure because the step at the one end is large, so that the separator may be broken to cause a short circuit.

Therefore, the present technology is directed to providing a highly producible battery having a structure in which a current collector is not exposed at one end on a winding start side of a positive electrode and having a structure capable of preventing an internal short circuit according to an embodiment.

In order to solve the above-described problems, the present technology, in an embodiment, provides a secondary battery including an electrode wound body having a structure in which a positive electrode having a belt shape and a negative electrode having a belt shape are stacked and wound with a separator interposed between the positive electrode having a belt shape and the negative electrode having a belt shape and an exterior can housing the electrode wound body,

in which

the positive electrode includes positive electrode active material layers on both surfaces of a positive electrode foil having a belt shape,

the positive electrode has two edges being intersections of an end surface on a winding start side and surfaces of the positive electrode active material layers in sectional view of the positive electrode, and

an insulating member having a length of 10 mm or more and 40 mm or less is disposed on a surface of the separator on the winding start side of the electrode wound body at a position facing at least one of the edges of a positive electrode.

According to an embodiment of the present technology, it is possible to provide a highly producible battery having a structure capable of preventing an internal short circuit. Note that the contents of the present application are not to be construed as being limited by the effects exemplified in the present specification.

### BRIEF DESCRIPTION OF THE FIGURES

FIG. 1 includes view A which is a sectional view of a battery according to an embodiment, and view B which shows positions of edges of a positive electrode and an end surface of the positive electrode.

FIG. 2 is a sectional view of an electrode wound body of Example 1 on a winding start side.

FIG. 3 is a sectional view of an electrode wound body of Comparative Example 1 on the winding start side.

FIG. 4 is a sectional view of an electrode wound body of Comparative Example 2 on the winding start side.

FIG. 5 is a sectional view of an electrode wound body of Comparative Example 3 on the winding start side.

FIG. 6 is a sectional view of an electrode wound body of Comparative Example 4 on the winding start side.

FIG. 7 is a connection diagram used for describing a battery pack as an application example of the present technology.

FIG. 8 is a connection diagram used for describing a power tool as an application example of the present technology.

FIG. 9 is a connection diagram used for describing an electric vehicle as an application example of the present technology.

### DETAILED DESCRIPTION

The present application will be described below in further detail with reference to the drawings according to one or more embodiments.

The present technology described below are preferred specific examples of the present technology according to an embodiment, and the content of the present technology is not limited.

In an embodiment of the present technology, a cylindrical lithium ion battery will be described as an example of the secondary battery. It is noted a battery other than lithium ion batteries or a battery having a shape other than a cylindrical shape may be used according to an embodiment.

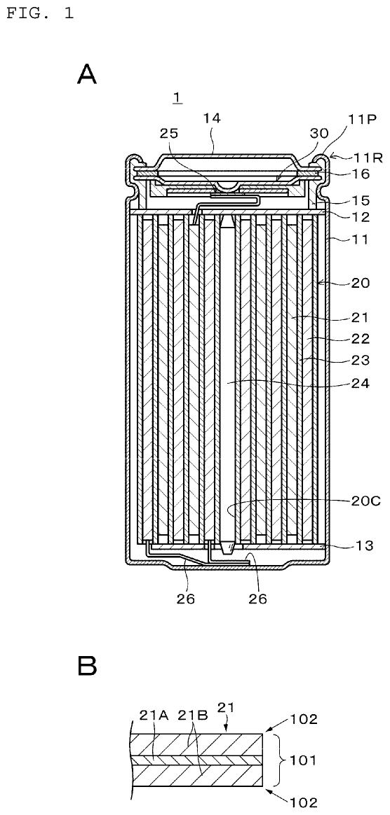

First, the overall configuration of the lithium ion battery will be described. FIG. 1A is a schematic sectional view of a lithium ion battery 1. The lithium ion battery 1 is, for example, a cylindrical lithium ion battery 1 in which an electrode wound body 20 is housed inside an exterior can 11 as shown in FIG. 1A.

Specifically, the lithium ion battery 1 includes a pair of insulating plates 12 and 13 and the electrode wound body 20 inside the cylindrical exterior can 11. The lithium ion battery 1 may further include any one of, or two or more of a thermosensitive resistor (positive temperature coefficient thermal-resistor or PTC), a reinforcing member, and the like inside the exterior can 11.

The exterior can 11 is a member that mainly houses the electrode wound body 20. The exterior can 11 is a cylindrical container in which one end portion is opened and the other end portion is closed. That is, the exterior can 11 has one end portion (open end) that is opened. The exterior can 11 contains any one of, or two or more of metal materials such as iron, aluminum, and alloys thereof. However, the surface of the exterior can 11 may be plated with any one of, or two or more of metal materials such as nickel.

The insulating plates 12 and 13 are sheet-like members having surfaces substantially perpendicular to the winding axis direction (vertical direction in FIG. 1A) of the electrode wound body 20. The insulating plates 12 and 13 are disposed so as to sandwich the electrode wound body 20 therebetween. As a material of the insulating plates 12 and 13, polyethylene terephthalate (PET), polypropylene (PP), Bakelite, or the like is used. Examples of Bakelite include paper Bakelite and cloth Bakelite produced by applying a phenolic resin to paper or cloth and then heating the paper or cloth.

A battery lid 14 and a safety valve mechanism 30 are crimped at the open end portion of the exterior can 11 with a gasket 15 interposed therebetween, so that a crimped structure 11R (crimp structure) is formed. As a result, the exterior can 11 is sealed in a state where the electrode wound body 20 and the like are housed inside the exterior can 11.

The battery lid 14 is a member that closes the open end portion of the exterior can 11 in a state where the electrode wound body 20 and the like are housed inside the exterior can 11. The battery lid 14 contains the same material as the material for forming the exterior can 11. The central region of the battery lid 14 protrudes in the vertical direction in FIG. 1A. On the other hand, a region (peripheral region) other than the central region of the battery lid 14 is in contact with the safety valve mechanism 30 with a PTC element 16 interposed therebetween.

The gasket 15 is a member that mainly seals a gap between a bent portion 11P (also referred to as a crimp portion) of the exterior can 11 and the battery lid 14 by being interposed between the bent portion 11P and the battery lid 14. For example, asphalt or the like may be applied to the surface of the gasket 15.

The gasket 15 contains an insulating material. The type of the insulating material is not particularly limited and is a polymer material such as polybutylene terephthalate (PBT) and polypropylene (PP). This is because the gap between the bent portion 11P and the battery lid 14 is sufficiently sealed while the exterior can 11 and the battery lid 14 are electrically separated from each other.

The safety valve mechanism 30 mainly releases the internal pressure by canceling the sealed state of the exterior can 11 as necessary when the pressure (internal pressure) inside the exterior can 11 has increased. One cause of the increase in the internal pressure of exterior can 11 is a gas generated due to a decomposition reaction of the electrolytic solution during charging and discharging.

In the cylindrical lithium ion battery, a positive electrode 21 having a belt shape and a negative electrode 22 having a belt shape are spirally wound with a separator 23 interposed therebetween and are housed in the exterior can 11 in a state of being impregnated with an electrolytic solution. Although not illustrated, the positive electrode 21 and the negative electrode 22 are respectively obtained by forming a positive electrode active material layer and a negative electrode active material layer on one side or both sides of a positive electrode foil and a negative electrode foil. The material of the positive electrode foil is a metal foil containing aluminum or an aluminum alloy. A material of the negative electrode foil is a metal foil containing nickel, a nickel alloy, copper, or a copper alloy. The separator 23 is a porous insulating film and enables movement of lithium ions while electrically insulating the positive electrode 21 and the negative electrode 22.

At the center of the electrode wound body 20, a space (central space 20C) formed when the positive electrode 21, the negative electrode 22, and the separator 23 are wound is provided, and a center pin 24 is inserted into the central space 20C (FIG. 1A). However, the center pin 24 can be omitted.

A positive electrode lead 25 is connected to the positive electrode 21, and a negative electrode lead 26 is connected to the negative electrode 22 (FIG. 1A). The positive electrode lead 25 contains a conductive material such as aluminum. The positive electrode lead 25 is connected to the safety valve mechanism 30 and is electrically connected to the battery lid 14 via the PTC element. The negative electrode lead 26 contains a conductive material such as nickel. The negative electrode lead 26 is electrically connected to the exterior can 11. Detailed configurations and materials of the positive electrode 21, the negative electrode 22, the separator 23, and the electrolytic solution will be described later.

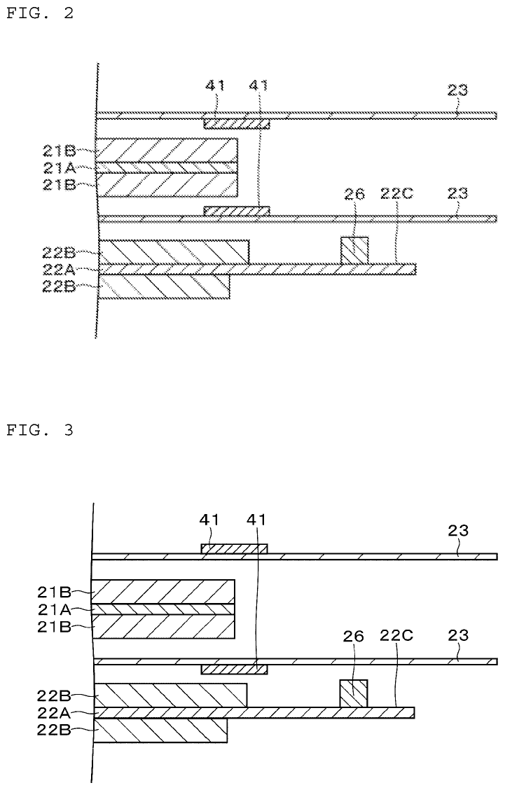

As shown in FIG. 2A, the positive electrode 21 includes, from one end on the winding start side to the other end on the winding end side in this order, a double-sided active material forming portion in which positive electrode active material layers 21B are formed on both main surfaces of a positive electrode foil 21A, a double-sided active material non-forming portion in which the positive electrode active material layers 21B are not formed on both main surfaces of the positive electrode foil and in which both main surfaces of the positive electrode foil 21A are exposed, and a double-sided active material forming portion in which the positive electrode active material layers 21B are formed on both main surfaces of the positive electrode foil 21A. The double-sided active material non-forming portion is provided substantially at a central portion in the longitudinal direction of the positive electrode 21. The positive electrode active material layers contain at least a positive electrode material (positive electrode active material) capable of occluding and releasing lithium and may further contain a positive electrode binder, a positive electrode conductive agent, and the like. The positive electrode material is preferably a lithium-containing compound (such as a lithium-containing composite oxide and a lithium-containing phosphate compound).

The lithium-containing composite oxide has, for example, a layered rock salt or spinel crystal structure. The lithium-containing phosphate compound has, for example, an olivine crystal structure.

The positive electrode binder contains synthetic rubber or a polymer compound. Examples of the synthetic rubber include styrene-butadiene rubber, fluorocarbon rubber, and ethylene propylene diene. Examples of the polymer compound include polyvinylidene fluoride (PVdF) and a polyimide.

The positive electrode conductive agent is a carbon material such as graphite, carbon black, acetylene black, and Ketjen black. However, the positive electrode conductive agent may be a metal material and a conductive polymer.

The surfaces of the negative electrode foil are preferably roughened. This is because the adhesion of the negative electrode active material layers to the negative electrode foil is improved by what is called an anchor effect. As a method of roughening, for example, there is a method of forming fine particles using an electrolytic method and providing irregularities on the surfaces of the negative electrode foil. A copper foil produced by an electrolytic method is generally called an electrolytic copper foil.

The negative electrode active material layers contain at least a negative electrode material (negative electrode active material) capable of occluding and releasing lithium and may further contain a negative electrode binder, a negative electrode conductive agent, and the like.

The negative electrode material contains, for example, a carbon material. This is because a change in the crystal structure at the time of occlusion and release of lithium is very small, so that a high energy density can be stably obtained. In addition, since the carbon material also functions as a negative electrode conductive agent, the conductivity of the negative electrode active material layers is improved.

The carbon material is graphitizable carbon, non-graphitizable carbon, graphite, low crystalline carbon, or amorphous carbon. The shape of the carbon material is fibrous, spherical, granular, or flaky.

The negative electrode material contains, for example, a metal material. Examples of the metal material include Li (lithium), Si (silicon), Sn (tin), Al (aluminum), Zr (zinc), and Ti (titanium). The metal element forms a compound, a mixture, or an alloy with another element, and examples thereof include silicon oxide (SiOₓ (0<x≤2)), silicon carbide (SiC), an alloy of carbon and silicon, and lithium titanate (LTO).

In the lithium ion battery 1, when the open circuit voltage (that is, the battery voltage) at the time of full charge is 4.25 V or more, the release amount of lithium per unit mass increases as compared with the case where the open circuit voltage at the time of full charge is low also in the case where the same positive electrode active material is used. Accordingly, a high energy density can be obtained.

The separator 23 is a porous membrane containing a resin and may be a laminated membrane of two or more kinds of porous membranes. Examples of the resin include polypropylene and polyethylene.

The separator 23 may include a resin layer on one side or both sides of a porous membrane as a substrate layer. This is because the adhesion of the separator 23 to each of the positive electrode 21 and the negative electrode 22 is improved, so that the distortion of the electrode wound body 20 is suppressed.

The resin layer contains a resin such as PVdF. In the case of forming this resin layer, a solution in which a resin is dissolved in an organic solvent is applied to the substrate layer, and then the substrate layer is dried. It is also possible to immerse the substrate layer in the solution and to dry the substrate layer. The resin layer preferably contains inorganic particles or organic particles from the viewpoint of improving the heat resistance and the safety of the battery. The type of the inorganic particles is aluminum oxide, aluminum nitride, aluminum hydroxide, magnesium hydroxide, boehmite, talc, silica, mica, or the like. In place of the resin layer, a surface layer formed by a sputtering method, an atomic layer deposition (ALD) method, or the like and containing inorganic particles as a main component may be used.

The electrolytic solution contains a solvent and an electrolyte salt and may further contain an additive or the like as necessary. The solvent is a nonaqueous solvent such as an organic solvent, or water. An electrolytic solution containing a nonaqueous solvent is referred to as a nonaqueous electrolytic solution. Examples of the nonaqueous solvent include a cyclic carbonate ester, a chain carbonate ester, lactone, a chain carboxylate ester, and a nitrile (mononitrile).

A representative example of the electrolyte salt is a lithium salt, but a salt other than the lithium salt may be contained. Examples of the lithium salt include lithium hexafluorophosphate (LiPF₆), lithium tetrafluoroborate (LiBF₄), lithium perchlorate (LiClO₄), lithium methanesulfonate (LiCH₃SO₃), lithium trifluoromethanesulfonate (LiCF₃SO₃), and dilithium hexafluorosilicate (Li₂SF₆). These salts can also be used in mixture, and among them, it is preferable to use LiPF₆ and LiBF₄ in mixture from the viewpoint of improving battery characteristics. The content of the electrolyte salt is not particularly limited but is preferably 0.3 mol/kg to 3 mol/kg with respect to the solvent.

In the lithium ion battery 1 of the one embodiment, an insulating member is disposed on the positive electrode 21 and the negative electrode 22 before winding. Here, the configuration of the insulating member will be described, and the attaching position of the insulating member and the like will be described in examples and comparative examples. The insulating member is, for example, an insulating tape. The substrate layer of the insulating tape is preferably a resin such as polyethylene (PE), polypropylene (PP), polyethylene terephthalate (PET), polyimide (PI), and polyphenylene sulfide (PPS) or a resin containing glass fiber. An adhesive constituting the adhesive layer of the insulating tape is preferably a material that does not adversely affect battery performance, and examples thereof include rubber adhesives, acrylic adhesives, silicone adhesives, and urethane adhesives. In particular, an acrylic adhesive is preferable.

In order to exhibit an insulating function in the battery, the thickness of the substrate layer of the insulating tape is preferably 1 μm or more. In order to protect the electrode wound body from damage and the like caused when the electrode wound body is inserted into the cylindrical exterior can, the thickness of the substrate layer of the insulating tape is required be great to some extent, but in order to secure the roundness of the electrode wound body, the thickness of the substrate layer of the insulating tape is preferably 100 μm or less. The thickness of the substrate layer of the insulating tape is more preferably 18 μm or more and 50 μm or less. At this time, the thickness of the substrate layer of the insulating tape is 10% or more and 60% or less of the thickness of the positive electrode. The thickness of the substrate layer of the insulating tape is therefore preferably 10% or more and 60% or less of the thickness of the positive electrode. The insulating tape preferably has a predetermined length. The predetermined length is such a length that the insulating tape can maintain a role as a protective material and the insulating tape does not interfere with movement of Li ions through the separator. For example, the length of the insulating tape is preferably 10 mm or more and 40 mm or less. The width of the insulating tape is preferably 1 mm or more greater than the width of the positive electrode 21. This is because although there may be winding deviation of the electrode wound body, breakage of the separator in contact with edges 102 of an end surface 101 of the positive electrode 21 can be prevented to prevent a short circuit. The width of the insulating tape may be greater than the width of the separator 23, but the width protruding from the separator 23 is preferably 1 mm or less on one side. This is because by setting the protrusion width to 1 mm or less on one side, it is possible to suppress an increase in size of the electrode wound body and to prevent a decrease in energy density of the battery.

The insulating member may be an insulating layer provided by applying a coating material containing a resin. The insulating layer preferably contains inorganic particles such as boehmite and alumina. In this case, the thickness of the insulating layer is preferably 1 μm or more and 100 μm or less for the same reason as the insulating tape.

Next, a method for manufacturing a secondary battery will be described. First, in the case of producing the positive electrode 21, a positive electrode mixture is produced by mixing the positive electrode active material, the positive electrode binder, and the positive electrode conductive agent. Subsequently, the positive electrode mixture is dispersed in an organic solvent to prepare a paste-like positive electrode mixture slurry. Subsequently, the positive electrode mixture slurry is applied to both surfaces of the positive electrode foil and then dried to form the positive electrode active material layers. Subsequently, while the positive electrode active material layers are heated, the positive electrode active material layers are compression-molded using a roll press machine to provide the positive electrode 21.

In the case of forming the negative electrode 22, 86 parts by mass of graphite and 15 parts by mass of Si as the negative electrode active material, 1 part by mass of the conductive agent, and 3 parts by mass of the binder are mixed to provide a negative electrode mixture, and then the negative electrode mixture is dispersed in water to provide a paste-like negative electrode mixture slurry. Subsequently, the negative electrode mixture slurry is applied to both surfaces of the negative electrode foil and then dried to form the negative electrode active material layers. Subsequently, while the negative electrode active material layers are heated, the negative electrode active material layers are compression-molded using a roll press machine to provide the negative electrode 22. The mass ratio of SiO to graphite and SiO is preferably 15% or more and 30% or less. This is because when the mass ratio of SiO is 15% or more, the discharge capacity of the battery can be increased. Since expansion and contraction of the negative electrode are severe along with charging and discharging if it exceeds 30%, the separator separating the positive electrode and the negative electrode may be broken to cause an internal short circuit. By setting the mass ratio of SiO to 30% or less, an internal short circuit of the battery can be prevented.

Next, the positive electrode lead 25 and the negative electrode lead 26 are respectively connected to the positive electrode foil and the negative electrode foil by welding. Subsequently, the positive electrode 21 and the negative electrode 22 are stacked with the separator 23 interposed therebetween and then wound, and a fixing tape 31 is attached to the outermost peripheral surface of the separator 23 to form the electrode wound body 20.

Subsequently, the electrode wound body 20 is housed inside the exterior can 11 in a state where an insulator is in contact with the side where the negative electrode lead 26 is exposed of the electrode wound body 20, and the bottom of the can and the negative electrode lead 26 are connected by welding. Next, an insulator is also placed on the side of the electrode wound body 20 where the positive electrode lead 25 is exposed, and one end of the positive electrode lead 25 is connected to the safety valve mechanism 30 by welding.

Subsequently, the exterior can 11 is processed using a beading machine (grooving machine) to form a recess in the exterior can 11. Subsequently, the electrolytic solution is injected into the exterior can 11 to impregnate the electrode wound body 20 with the electrolytic solution. Subsequently, the battery lid 14 and the safety valve mechanism 30 are housed inside the exterior can 11 together with the gasket 15.

Finally, as shown in FIG. 1A, the battery lid 14 and the safety valve mechanism 30 are crimped at the open end portion of the exterior can 11 with the gasket 15 interposed therebetween to form the crimped structure 11R.

### EXAMPLES

The present technology will be specifically described below on the basis of examples in which an internal short circuit (short circuit) and producibility were tested using the battery 1 prepared as described above according to an embodiment. Note that the present technology is not limited to the examples described below.

FIGS. 2 to 6 are sectional views of the positive electrode 21 (the positive electrode foil 21A, the positive electrode active material layers 21B, and a portion 21C not covered with the active material of the positive electrode), the negative electrode 22 (the negative electrode foil 22A, the negative electrode active material layers 22B, and a portion 22C not covered with the active material of the negative electrode), and the separator 23 before being wound on the winding start side of the electrode wound body. FIG. 1B is a sectional view of one end on the winding start side of the positive electrode 21, which has the end surface 101 cut at a portion where the positive electrode active material layers 21B are provided on both sides of the positive electrode foil 21A. In sectional view, the two edges 102 are provided at the intersections of the surfaces of the positive electrode active material layers 21B and the end surface 101. Although not illustrated, the other end of the positive electrode 21 has the same structure. The battery sizes of all the examples and comparative examples were 18650 (cylindrical battery having a diameter of 18 mm and a length of 65 mm).

### Example 1

As shown in FIG. 2, insulating members 41 were disposed on the surfaces of the separators on the winding start side of the electrode wound body at positions facing the edges 102 of the positive electrode. The insulating members 41 were constituted of an insulating tape including a polyimide substrate layer having a thickness of 25 μm and an adhesive layer having a thickness of 5 μm, and the length was 30 mm.

### Comparative Example 1

As shown in FIG. 3, insulating members 41 were disposed on the surfaces of the separators on the winding start side of the electrode wound body, the surfaces being opposite to the positions facing the edges 102 of the positive electrode. The insulating members 41 were constituted of the same insulating tape as that in Example 1.

### Comparative Example 2

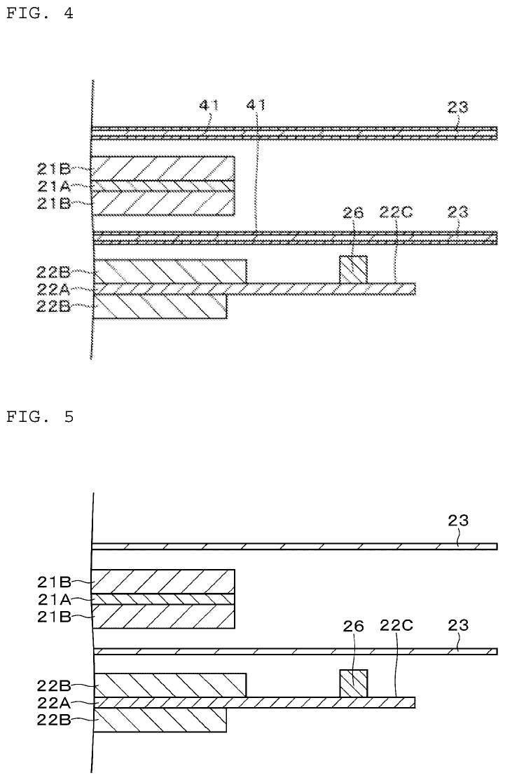

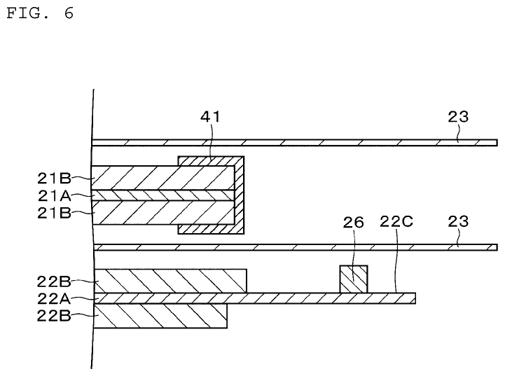

As shown in FIG. 4, insulating members 41 were disposed on the entire surfaces of the separators of the electrode wound body. The insulating members 41 were insulating layers formed by coating with a coating material containing alumina particles and polyvinylidene fluoride. The thickness of the insulating members 41 (insulating layers containing alumina particles) was 2 μm.

### Comparative Example 3

As shown in FIG. 5, no insulating member 41 was disposed on the separators on the winding start side of the electrode wound body.

### Comparative Example 4

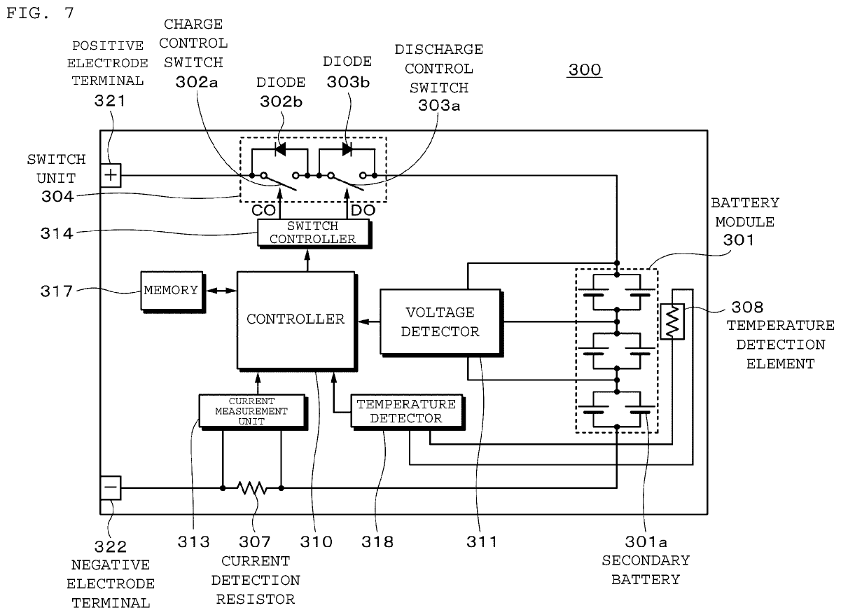

As shown in FIG. 6, the edges 102 and the end surface 101 of the positive electrode on the winding start side of the electrode wound body were covered with an insulating member 41. The insulating members 41 were constituted of the same insulating tape as that in Example 1.

For the batteries 1 of the example and the comparative examples described above, an inspection of a short-circuit occurrence rate during charging and a drop test after a low-temperature cycle test were performed, producibility was further judged, and evaluation was performed.

The inspection of the short-circuit occurrence rate during charging will be described. After assembling the battery 1, constant current charging was performed under the conditions of an ambient temperature of 23° C. and a charging current of 100 mA, and switching to constant voltage charging was performed when the battery voltage reached 4.2 V. The case where the battery voltage suddenly dropped or where heat was abnormally generated during charging was judged to be a short-circuit failure. The number of batteries 1 used for the inspection of the short-circuit occurrence rate during charging was 100, and the short-circuit occurrence rate was calculated from the number of short-circuit defects.

The drop test will be described. A drop test was performed after the low-temperature cycle of the battery 1 to determine the short-circuiting occurrence rate.

The low-temperature cycle was performed as follows.

Ambient temperature: 0° C.

### Charge: CC/CV, 4.25 V/1C, 100 mA cut

Discharge: 2 C, 2 V cut (charging is resumed when the cell temperature after discharging reaches 0° C.)

The discharge rate was lowered to 1 C when the retention ratio [%] with respect to the initial discharge capacity was 30% or less, the discharge rate was lowered to 0.5 C when the retention ratio [%] was 30% or less, and the test was performed up to 30% or less.

The drop test after the low-temperature cycle was performed as follows. Some modifications were made to those specified in “Guidelines for Evaluation of Safety of Lithium Secondary Batteries” (SBA G1101), and the modified standards were employed. Specifically, the drop test prescribed in the SBA G1101 is a test of dropping 10 times from a height of 1.9 m onto concrete, but in the drop test of this evaluation, the number of times of dropping was set to 20 times. The number of batteries 1 used in the drop test was 100, and the rate of occurrence of internal short-circuiting of the batteries 1 was defined as the short-circuiting occurrence rate by the drop test.

The first charge capacity after the battery is assembled is the first charge capacity (mAh). An average value was calculated from the measured values of 10 batteries. Each value is represented with the value in Example 1 being set to 100.

For the determination of producibility, an example in which production can be performed using a winding device or the like and mass production can be performed is considered to have good producibility. An example in which mass production was not possible was regarded to have poor producibility.

TABLE 1

| | Short-circuit | Short-circuiting occurrence | |
|---|---|---|---|
| | occurrence rate | rate by drop test after low- | Produc- |
| | during charging (%) | temperature cycle (%) | ibility |
| Example 1 | 0 | 0 | Good |
| Comparative | 100 | — | Good |
| Example 1 | | | |
| Comparative | 0 | 15 | Good |
| Example 2 | | | |
| Comparative | 0 | 35 | Good |
| Example 3 | | | |
| Comparative | 0 | 0 | Poor |
| Example 4 | | | |

In Example 1, the short-circuit occurrence rate during charging was 0%, the short-circuit occurrence rate by the drop test was 0%, and the producibility was good. On the other hand, in Comparative Examples 1 to 3, the short-circuit occurrence rate during charging or the short-circuit occurrence rate by the drop test after a low-temperature cycle was not 0%, and in Comparative Example 4, the producibility was poor. This is because it is technically difficult to continuously cover the end surface 101 and the edge 102 of the positive electrode with one insulating member 41 in the winding device, and a manual process is adopted. In Comparative Example 1, it is considered that since the insulating members 41 were disposed on the surfaces of the separators 23 facing the negative electrode active material layers, Li metal was precipitated on the surfaces of the negative electrode in the process of charging to 4.2 V, and an internal short circuit occurred. Since an internal short circuit occurred during such a charging process, a drop test was not conducted for Comparative Example 1. In Comparative Example 2, the insulating members 41 were disposed on the entire surfaces of the separators, but short circuits of 15% occurred in the drop test after the low-temperature cycle test. This is presumed to be because expansion and contraction of the negative electrode were repeated in the process of charging and discharging, and expansion due to precipitation of metallic lithium on the surfaces of the negative electrode is also applied particularly at a low temperature, so that strong stress is repeatedly applied to the separator. It is presumed that the separators in contact with portions forming large steps in the electrode wound body, that is, the edges 102 (see FIG. 1B) of the positive electrode end surface on the winding start side, were broken to cause a short circuit. In Comparative Example 3, no insulating member 41 was disposed on the separators on the winding start side of the electrode wound body. Short circuits of 35% occurred in the drop test after the low-temperature cycle test. The cause of the short circuit is considered to be the same as in Comparative Example 2. From Table 1, it can be judged that the battery 1 of Example 1 is a highly producible battery having a structure capable of preventing a short circuit during charging and preventing a short circuit in a drop test after a low-temperature cycle.

Next, a battery was produced with the length of the insulating tape used as the insulating members 41 changed from Example 1 (length: 30 mm).

### Example 2

The procedure was the same as that in Example 1 except that the length of the insulating members 41 was changed to 10 mm.

### Example 3

The procedure was the same as that in Example 1 except that the length of the insulating members 41 was changed to 40 mm.

### Comparative Example 5

The procedure was the same as that in Example 1 except that the length of the insulating members 41 was changed to 5 mm.

### Comparative Example 6

The procedure was the same as that in Example 1 except that the length of the insulating members 41 was changed to 50 mm.

For the batteries 1 of Examples 1 to 3 and Comparative Examples 5 and 6, the drop test after the low-temperature cycle test was performed in the same manner, the producibility was further judged, and the initial charge capacities of the batteries were determined and evaluated. For the initial charge capacities of the batteries, the value in Example 1 was set to 100.

TABLE 2

| | | | Short-circuiting | | |
|---|---|---|---|---|---|
| | | Short-circuit | occurrence rate by | | |
| | Length of | occurrence | drop test after | First charge | |
| | insulating | rate during | low-temperature | capacity of | |
| | member (mm) | charging (%) | cycle (%) | battery | Producibility |
| Example 1 | 30 | 0 | 0 | 100 | Good |
| Example 2 | 10 | 0 | 0 | 101.3 | Good |
| Example 3 | 40 | 0 | 0 | 99.4 | Good |
| Comparative | 5 | 0 | 0 | 101.6 | Poor |
| Example 5 | | | | | |
| Comparative | 50 | 0 | 0 | 98.7 | Good |
| Example 6 | | | | | |

In Comparative Example 5, since the length of the insulating tape was too small, the accuracy of the positions where the insulating tape was attached to the separators was low, and the producibility was poor. In Comparative Example 6, since the insulating tape was excessively long, the reaction area was relatively small, and the first charge capacity of the battery was low. From the above results, it was found that the length of the insulating tape is preferably 10 mm or more and 40 mm or less.

Although an embodiment of the present technology has been specifically described above, the content of the present technology is not limited, and various modifications based on the technical idea of the present technology are contemplated and possible.

Although the insulating tape and the insulating layer are exemplified as the insulating members 41, any material may be used as long as it is an electrically insulating material and an electrochemically stable material.

FIG. 7 is a block diagram illustrating a circuit configuration example when the secondary battery according to the embodiment or the examples of the present technology is applied to a battery pack 300. The battery pack 300 includes a battery module 301, a switch unit 304 including a charge control switch 302a and a discharge control switch 303a, a current detection resistor 307, a temperature detection element 308, and a controller 310. The controller 310 can control each device, further perform charge and discharge control at the time of abnormal heat generation, and calculate and correct the remaining capacity of the battery pack 300.

When the battery pack 300 is charged, a positive electrode terminal 321 and a negative electrode terminal 322 are respectively connected to a positive electrode terminal and a negative electrode terminal of a charger, and charging is performed. When an electronic device connected to the battery pack 300 is used, the positive electrode terminal 321 and the negative electrode terminal 322 are respectively connected to a positive electrode terminal and a negative electrode terminal of the electronic device, and discharge is performed.

The battery module 301 is formed by connecting a plurality of secondary batteries 301a in series and/or in parallel. FIG. 7 shows, as an example, the case where six secondary batteries 301a are connected in two parallel connections and three series connections (2P3S), but any connection method may be used.

A temperature detector 318 is connected to the temperature detection element 308 (such as a thermistor), measures the temperature of the battery module 301 or the battery pack 300, and supplies the measured temperature to the controller 310. A voltage detector 311 measures the voltages of the battery module 301 and the secondary batteries 301a constituting the battery module 301, performs A/D conversion on the measured voltages, and supplies the converted voltages to the controller 310. A current measurement unit 313 measures a current using the current detection resistor 307 and supplies the measured current to the controller 310.

A switch controller 314 controls the charge control switch 302a and the discharge control switch 303a of the switch unit 304 on the basis of the voltages and the current input from the voltage detector 311 and the current measurement unit 313. When the voltage of any of the secondary batteries 301a becomes equal to or lower than the overcharge detection voltage or the overdischarge detection voltage or when a large current rapidly flows, the switch controller 314 sends an OFF control signal to the switch unit 304 to prevent overcharge, overdischarge, and overcurrent charge and discharge. Here, when the secondary batteries are lithium ion secondary batteries, the overcharge detection voltage is set to be, for example, 4.20 V±0.05 V, and the overdischarge detection voltage is set to be, for example, 2.4 V±0.1 V.

After the charge control switch 302a or the discharge control switch 303a is turned off, charging or discharging can be performed only through a diode 302b or a diode 303b. As these charge/discharge switches, semiconductor switches such as a MOSFETs can be used. In this case, parasitic diodes of the MOSFETs function as the diodes 302b and 303b. The switch unit 304 is provided on the positive side in FIG. 7 but may be provided on the negative side.

A memory 317 includes a RAM or a ROM and includes, for example, an erasable programmable read only memory (EPROM), which is a nonvolatile memory. The memory 317 stores in advance numerical values calculated by the controller 310, battery characteristics in an initial state of each secondary battery 301a measured at a stage of a manufacturing process, and the like, which can be rewritten as appropriate. In addition, by storing the full charge capacity of the secondary batteries 301a, the remaining capacity can be calculated in cooperation with the controller 310.

The secondary battery according to an embodiment including the examples of the present technology described above can be mounted on a device such as an electronic device, electric transport equipment, or a power storage device to supply electric power.

Examples of the electronic device include a notebook computer, a smartphone, a tablet terminal, a personal digital assistant (PDA), a mobile phone, a wearable terminal, a video movie, a digital still camera, an electronic book, a music player, a headphone, a game machine, a pacemaker, a hearing aid, a power tool, a television, a lighting device, a toy, a medical device, and a robot. In addition, electric transport equipment, a power storage device, a power tool, and an electric unmanned aerial vehicle to be described later can also be included in electronic devices in a broad sense.

Examples of the electric transport equipment include an electric car (including a hybrid car), an electric motorcycle, an electric-assisted bicycle, an electric bus, an electric cart, an automatic guided vehicle (AGV), and a railway vehicle. In addition, electric passenger aircraft and electric unmanned aerial vehicles for transportation are also included. The secondary battery according to the present invention is used not only as the driving power supply but also as an auxiliary power supply, an energy regeneration power supply, and the like.

Examples of the power storage device include a power storage module for commercial use or household use and a power storage power source for a building such as a house, a building, or an office or for a power generation facility.

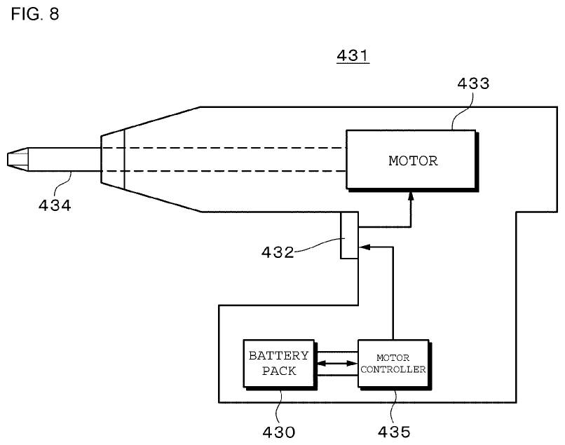

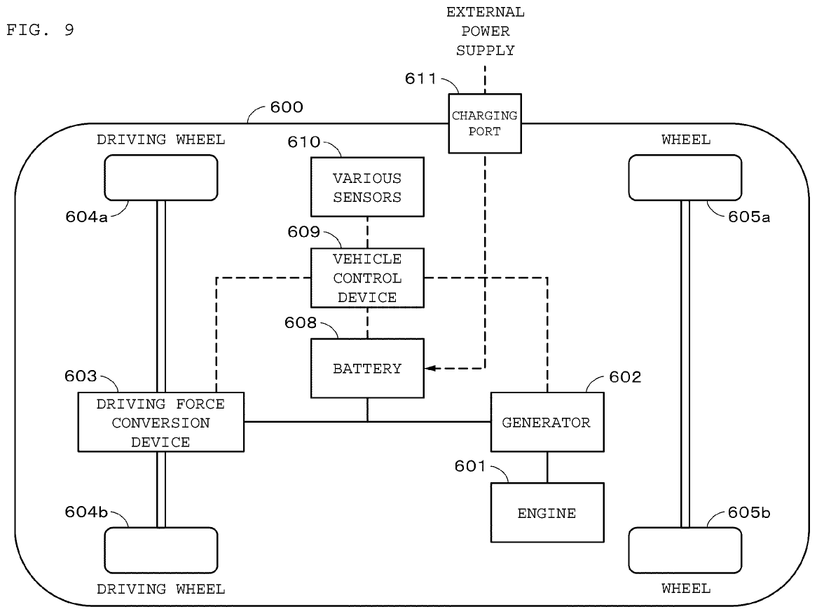

An electric driver will be schematically described as an example of the power tool to which the present technology can be applied with reference to FIG. 8. An electric driver 431 includes a motor 433 that transmits rotational power to a shaft 434 and a trigger switch 432 operated by a user. A screw or the like is driven into the target object by the shaft 434 through the operation of the trigger switch 432.

A battery pack 430 and a motor controller 435 are housed in a lower housing of a handle of the electric driver 431. As the battery pack 430, the battery pack 300 described above can be used. The battery pack 430 is built in the electric driver 431 or is detachable. The battery pack 430 can be attached to the charging device in a state of being built in or removed from the electric driver 431.

Each of the battery pack 430 and the motor controller 435 includes a microcomputer. Power is supplied from the battery pack 430 to the motor controller 435, and charge/discharge information of the battery pack 430 is transmitted between the microcomputers. The motor controller 435 can control rotation/stop and a rotation direction of the motor 433 and can further cut off power supply to a load (such as the motor 433) at the time of overdischarge.

As an example in which the present technology is applied to a power storage system for an electric vehicle, FIG. 9 schematically illustrates a configuration example of a hybrid vehicle (HV) employing a series hybrid system. The series hybrid system is a vehicle that travels with an electric power-driving force conversion device using electric power generated by a generator powered by an engine or electric power temporarily stored in a battery.

A hybrid vehicle 600 includes an engine 601, a generator 602, an electric power-driving force conversion device 603 (DC motor or AC motor, hereinafter simply referred to as a “motor 603”), a driving wheel 604a, a driving wheel 604b, a wheel 605a, a wheel 605b, a battery 608, a vehicle control device 609, various sensors 610, and a charging port 611. For the battery 608, the battery pack 300 of the present technology described above or a power storage module on which a plurality of secondary batteries of the present technology are mounted can be applied. The secondary battery has a cylindrical shape, a rectangular shape, or a laminate shape.

The motor 603 is operated by the electric power from the battery 608, and the rotational force of the motor 603 is transmitted to the driving wheels 604a and 604b. The rotational force of the engine 601 is transmitted to the generator 602, and electric power generated by the generator 602 by the rotational force can be stored in the battery 608. The various sensors 610 control the engine speed via the vehicle control device 609 and control the opening degree of a throttle valve (not illustrated). The various sensors 610 include a speed sensor, an acceleration sensor, an engine speed sensor, and the like.

When the hybrid vehicle 600 is decelerated by a braking mechanism (not illustrated), a resistance force at the time of deceleration is applied to the motor 603 as a rotational force, and regenerated power generated by the rotational force is accumulated in the battery 608. Although not illustrated, an information processing device (such as a remaining battery level display device) that performs information processing related to vehicle control based on information related to the secondary battery may be provided. The battery 608 is connected to an external power supply via the charging port 611 of the hybrid vehicle 600, thereby being capable of receiving power supply and storing power. Such an HV vehicle is referred to as a plug-in hybrid vehicle (PHV or PHEV).

Although the series hybrid vehicle has been described above as an example, the present technology is also applicable to a parallel system using an engine and a motor together or a hybrid vehicle employing a combination of a series system and a parallel system. Furthermore, the present technology is also applicable to an electric vehicle (EV or BEV) that travels only by a drive motor without an engine and a fuel cell vehicle (FCV).

### DESCRIPTION OF REFERENCE SYMBOLS

1: Lithium ion battery
12, 13: Insulating plate
21: Positive electrode
21A: Positive electrode foil
21B: Positive electrode active material layer
21C: Portion not covered with active material of positive electrode
22: Negative electrode
22A: Negative electrode foil
22B: Negative electrode active material layer
22C: Portion not covered with active material of negative electrode
23: Separator
24: Center pin
25: Positive electrode lead
26: Negative electrode lead
41: Insulating member

It should be understood that various changes and modifications to the presently preferred embodiments described herein will be apparent to those skilled in the art. Such changes and modifications can be made without departing from the spirit and scope the present subject matter and without diminishing its intended advantages. It is therefore intended that such changes and modifications be covered by the appended claims.

1. A secondary battery comprising:
an electrode wound body having a structure in which a positive electrode having a belt shape and a negative electrode having a belt shape are stacked and wound with a separator interposed between the positive electrode having a belt shape and the negative electrode having a belt shape; and
an exterior can housing the electrode wound body,
wherein
the positive electrode includes positive electrode active material layers on both surfaces of a positive electrode foil having a belt shape,
the positive electrode has two edges being intersections of an end surface on a winding start side and surfaces of the positive electrode active material layers in sectional view of the positive electrode, and
an insulating member having a length of 10 mm or more and 40 mm or less is disposed on a surface of the separator on the winding start side of the electrode wound body at a position facing at least one of the edges of the positive electrode.

2. The secondary battery according to claim 1, wherein
the positive electrode includes a double-sided active material forming portion including the positive electrode active material layers on both surfaces of the positive electrode foil; and
a double-sided active material non-forming portion in which both surfaces of the positive electrode foil are exposed, and
the double-sided active material forming portion, the double-sided active material non-forming portion, and the double-sided active material forming portion are provided in order from one end on the winding start side to another end on a winding end side of the positive electrode.

3. The secondary battery according to claim 1, wherein the insulating member includes a substrate layer containing a polymer material and an adhesive layer.

4. The secondary battery according to claim 3, wherein the polymer material includes at least one of polyethylene, polypropylene, polyester, or polyimide.

5. The secondary battery according to claim 3, wherein a thickness of the substrate layer of the insulating member is 10% or more and 60% or less of a thickness of the positive electrode.

6. The secondary battery according to claim 1, wherein a width of the insulating member is greater than a width of the positive electrode by 1 mm or more.

7. The secondary battery according to claim 1, wherein a protruding width of the insulating member from the separator is 1 mm or less.

8. An electronic device comprising the secondary battery according to claim 1.

9. A power tool comprising the secondary battery according to claim 1.
